(19) United States
(12) Patent Application Publication
(10) Pub. No.: US 2021/0326726 A1
(43) Pub. Date: Oct. 21, 2021

(54) USER EQUIPMENT REPORTING FOR UPDATING OF MACHINE LEARNING ALGORITHMS

(71) Applicant: QUALCOMM Incorporated, San Diego, CA (US)

(72) Inventors: Hua WANG, Basking Ridge, NJ (US); Junyi LI, Franklin Park, NJ (US); Jung Ho RYU, Fort Lee, NJ (US); Tianyang BAI, Somerville, NJ (US)

(21) Appl. No.: 17/233,374

(22) Filed: Apr. 16, 2021

Related U.S. Application Data
(60) Provisional application No. 63/011,156, filed on Apr. 16, 2020.

(51) Int. Cl. G06N 5/04; H04W 72/04; H04B 17/318; H04L 5/00; H04W 24/10; G06N 20/00

(52) U.S. Cl. CPC G06N 5/04; H04W 72/042; H04B 17/318; H04W 72/044; H04W 24/10; G06N 20/00; H04L 5/0048

(57) ABSTRACT

Wireless communications systems and methods related to user equipment reporting for updating of machine learning algorithms are provided. A user equipment (UE) applies a machine learning-based network to a set of received signal measurements. The UE determines whether an output of the machine learning-based network fails to satisfy one or more criteria. The UE communicates, with a base station (BS), a report when the output of the machine learning-based network fails to satisfy the one or more criteria. The BS communicates, with one or more UEs, a first configuration for a machine learning-based network. The BS receives, from a first UE of the one or more UEs, a report associated with a prediction error in the machine learning-based network. The BS communicates, with the first UE, a second configuration for the machine learning-based network based on the received report.

### CROSS-REFERENCE TO RELATED APPLICATIONS

The present application claims priority to and the benefit of the U.S. Provisional Patent Application No. 63/011,156, filed Apr. 16, 2020, titled “User Equipment Reporting for Updating of Machine Learning Algorithms,” which is incorporated by reference herein in its entirety as if fully set forth below and for all applicable purposes.

### TECHNICAL HELD

This application relates to wireless communication systems, and more particularly to user equipment reporting for updating of machine learning algorithms.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. The radio frequency channel through which the BS and the UE communicate may have several channel properties that are considered for proper channel performance. The BS and UE may perform channel sounding to better understand these channel properties by measuring and/or estimating various parameters of the channel, such as delay, path loss, absorption, multipath, reflection, fading, doppler effect, among others. These channel measurements can also be used for channel estimation and channel equalization.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a UE includes applying a machine learning-based network to a set of received signal measurements; determining whether an output of the machine learning-based network fails to satisfy one or more criteria; and communicating, by the UE with a BS, a report when the output of the machine learning-based network fails to satisfy the one or more criteria.

In an additional aspect of the disclosure, a UE includes a processor configured to apply a machine learning-based network to a set of received signal measurements; and determine whether an output of the machine learning-based network fails to satisfy one or more criteria; and a transceiver configured to communicate, with a BS, a report when the output of the machine learning-based network fails to satisfy the one or more criteria.

For example, in another aspect of the disclosure, a method of wireless communication performed by a BS includes communicating, by the BS with one or more UEs, a first configuration for a machine learning-based network; receiving, from a first UE of the one or more UEs, a report associated with a prediction error in the machine learning-based network; and communicating, by the BS with the first UE, a second configuration for the machine learning-based network based on the received report.

In another additional aspect of the disclosure, a BS includes a transceiver configured to communicate, with one or more UEs, a first configuration for a machine learning-based network; receive, from a first UE of the one or more UEs, a report associated with a prediction error in the machine learning-based network; and communicate, with the first UE, a second configuration for the machine learning-based network based on the received report.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for user equipment reporting according to some aspects of the present disclosure.

FIG. 3 is a block diagram of a user equipment according to some aspects of the present disclosure.

FIG. 4 is a block diagram of an exemplary base station according to some aspects of the present disclosure.

FIG. 5 is a simplified diagram of an example frame exchange between a user equipment and a base station for user equipment reporting for updating a machine learning network according to some aspects of the present disclosure.

FIG. 6 is a simplified diagram of another example frame exchange between a user equipment and a base station for user equipment reporting for updating a machine learning network according to some aspects of the present disclosure.

FIG. 7 is a simplified diagram of another example frame exchange between a user equipment and a base station for user equipment reporting for updating a machine learning network according to some aspects of the present disclosure.

FIG. 8 is a flow diagram of an example process of reporting performed by a user equipment for updating a machine learning network according to some aspects of the present disclosure.

FIG. 9 is a flow diagram of an example process of a machine learning network update performed by a base station using user equipment reporting according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²) extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5. 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

A wireless channel between the network (e.g., a BS) and a UE may vary over time. The BS may configure a set of beams for the UE, which at any point of time may use one or two serving beams to receive DL transmissions from or transmit UL transmissions to the BS. The BS and the UE may keep track of the serving beam(s) as well as candidate beams. For example, the UE may perform one or more measurements of one or more reference signals configured for the UE and may include the one or more measurements in a channel state information (CSI) report. If a serving beam fails, the BS may reconfigure the UE to use of the candidate beams. Candidate beams may be regularly updated because the channel quality between the BS and the UE may change over time. It may be desirable for the UE update the serving beam(s) according to the channel state. The UE may report the link quality of the serving beam(s) and the candidate beams in a CSI report to the BS, and the BS may process the CSI report and determine whether the UE's serving beam(s) or candidate beam(s) should be reconfigured. If the quality of a beam falls below a threshold, the BS may reconfigure a beam the UE's serving beam(s) or candidate beam(s). The BS may configure the threshold. Based on the determination, the BS may transmit a command to reconfigure the UE's serving beam(s) and/or candidate beam(s) in response to the CSI report.

The BS may configure the UE to periodically report the CSI report to the BS. The CSI report may include, for example, channel quality information (CQI) and/or reference signal received power (RSRP). CQI is an indicator carrying information on the quality of a communication channel. The BS may use the CQI to assist in downlink (DL) scheduling. The BS may use the RSRP to manage beams in multi-beam operations. The UE may perform different combinations of measurements for inclusion in the CSI report. Accordingly, the UE may transmit a CSI report including the CQI but not the RSRP, a CSI report including the RSRP but not the CQI, and/or a CSI report including both the CQI and the RSRP.

In 5G NR, machine learning (ML) algorithms are being implemented to assist cellular network performance. These ML algorithms may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

At each node implemented with one or more ML algorithms, the ML algorithms may interact with different layers within the node. The ML algorithms may interact with one of the physical layer (PHY), the media access control (MAC) layer or upper layers (e.g., application layer) in some instances, or with multiple layers in other instances. For example, a node may include a ML module adapted for low-density parity check (LDPC) decoding at the PHY layer. In another example, a node may include a ML Module for CSI prediction and/or transmission configuration indicator (TCI) selection at the PHY layer and the MAC layer. In another example, a node may include a ML Module for multi-user (MU) scheduling taking account for package latency and/or priority at the PHY layer, the MAC layer and the upper layers. These ML algorithms may involve various ML-related data transfers between different layers of different nodes (e.g., UE, BS, central cloud server). The ML algorithms may be trained with training datasets that are produced through periodic and/or aperiodic data collection at one or more nodes. In various aspects, measurement data collection serves as input to the ML modules. The operation of these ML algorithms at the different nodes may be used for ML model parameter transfer and/or update. The ML model framework within the wireless communication network has the capability to send feedback signals and/or reports between the different nodes. In various aspects, the UE may feed back channel measurements that are indicative of the ML model prediction accuracy. For example, the measurement data collection by the UE that is then sent to the BS and/or central cloud server with a report may indicate that the ML model is producing prediction errors, thus indicative that the ML model requires updating. The ML modules may provide intermediate data transfer between the different nodes (e.g. to facilitate training with stochastic gradient decent and backpropagation for a distributed ML algorithm).

In various aspects, the UE may include different ML algorithms on board to predict channel properties for a future use of that channel. For example, the machine learning-based network may be implemented by a channel property prediction network to predict one or more properties of a channel. In some aspects, the ML algorithms are tasked to predict what transmission beam to use for the BS and/or reception beam to use for the UE. For example, the machine learning-based network may be implemented by a beam selection prediction network to predict the BS transmission beam and/or the UE reception beam. In other aspects, the ML algorithms are tasked to predict what is the delay spread of a channel. For example, the machine learning-based network may be implemented by a delay spread prediction network to predict the delay spread on a channel. In still other aspects, the ML algorithms are tasked to predict when is a best time or condition to hand over channel communication to another BS, and further predict as to which BS to handover. For example, the machine learning-based network may be implemented by a handover prediction network to predict a proper handover condition and/or predict a handover destination. In various scenarios, the BS sends updates of neural networks to the UE to configure, the UE then feeds back sampled data to the BS, and the training and updating of the neural network(s) occurs at the central cloud server. Given the substantial amounts of collected sampled data that is sent back from the UE to the BS, this creates an increasingly burdensome task for the BS to process through the sampled data. Therefore, it is desirable for the UE to decide which sampled data is more useful to feed back to the BS for improving the quality of the ML algorithms.

The present disclosure provides techniques for the UE to feed back sampled data of the channel properties that correspond to an incorrect prediction (or generally referred to as “a prediction error” herein) to the BS to serve as more insightful data that helps improve the ML algorithms. To update the neural network(s), it may be more valuable to feed back the sampled data when a prediction error occurs. In various aspects, the UE is configured to teed back a subset of the sampled data that corresponds to a correct prediction to the BS since this sampled data may not be as indicative as to how to improve the ML algorithms other than to reassure that the ML algorithms are performing as expected.

Aspects of the present disclosure can provide several benefits. For example, by feeding back sampled data that corresponds to a prediction error and/or a subset of the sampled data that corresponds to a correct prediction, the ML-based system can reduce the amount of sampled data that needs to be fed back between the UE and the BS. This helps free up resource elements in the channel and also helps to reduce the burden created at the BS to process and/or determine which of the sampled data is most useful to train the neural network to achieve an increase in performance.

In some aspects, a UE includes a processor configured to apply a machine learning-based network to a set of received signal measurements and determine whether an output of the machine learning-based network fails to satisfy one or more criteria. The UE also may include a transceiver configured to communicate, with a BS, a report when the output of the machine learning-based network fails to satisfy the one or more criteria. In some aspects, the processor configured to determine whether the output of the machine learning-based network fails to satisfy the one or more criteria may be further configured to determine that the output of the machine learning-based network corresponds to a prediction error based on a comparison between at least one signal measurement in the set of received signal measurements and a signal measurement Obtained by the UE.

In some aspects, the transceiver configured to communicate the report may be further configured to transmit, to the BS in a first subband of a plurality of subbands, sampled data for updating the machine learning-based network. In some aspects, the first subband includes a plurality of physical uplink shared channels (e.g., PUSCHs) multiplexed in at least one of time or frequency in a first portion of a first time period, and the transceiver configured to transmit the sampled data may be further configured to transmit the sampled data in one or more PUSCHs of the plurality of PUSCHs. In some aspects, the sampled data includes a feedback pairing of at least one signal measurement in the set of received signal measurements and the output of the machine learning-based network associated with the at least one signal measurement.

In some aspects, the transceiver of the UE may be further configured to receive a predetermined threshold from the BS for use with the machine learning-based network. In some instances, the processor configured to determine whether the output of the machine learning-based network fails to satisfy the one or more criteria may be further configured to determine that the output of the machine learning-based network fails to satisfy the one or more criteria based on the predetermined threshold. In some aspects, the processor configured to determine that the output of the machine learning-based network fails to satisfy the one or more criteria may be further configured to determine whether a first signal measurement in the set of received signal measurements is greater than the predetermined threshold, and determine that the output of the machine learning-based network corresponds to a prediction error when the first signal measurement in the set of received signal measurements is not greater than the predetermined threshold. In some aspects, the predetermined threshold corresponds to a target reference signal received power (e.g., RSRP) value for a downlink specific reference signal. In some aspects, the downlink specific reference signal includes a synchronization signal block (e.g., SSB). In other aspects, the downlink specific reference signal comprises a channel state information reference signal (e.g., CSI-RS).

In some aspects, the transceiver of the UE is further configured to receive, in a first subband of a plurality of subbands, a request for the UE to measure sampled ground-truth data. In some instances, the processor is further configured to obtain the sampled ground-truth data in response to the request. In some aspects, the processor configured to determine whether the output of the machine learning-based network fails to satisfy the one or more criteria may be further configured to determine that the output of the machine learning-based network corresponds to a prediction error based on a comparison between at least one signal measurement in the set of received signal measurements and the sampled ground-truth data. In some aspects, the request includes a request for measurement of the sampled ground-truth data by the UE at a particular time instance during a first time period, in which the first subband includes a plurality of physical downlink control channels (PDCCHs) multiplexed in at least one of time or frequency in a first portion of the first time period. In some instances, the transceiver configured to receive the request may be further configured to receive the request in one or more PDCCHs of the plurality of PDCCHs. In some aspects, the request includes a request for the UE to perform a plurality of periodical signal measurements of the sampled ground-truth data. In some instances, the transceiver configured to receive the request may be further configured to receive the request in a radio resource control (e.g., RRC) signal.

In some aspects, the transceiver may be further configured to receive, in a first subband of a plurality of subbands, a request to communicate sampled data with the BS. In some instances, the transceiver configured to communicate the report may be further configured to communicate, with the BS, the report with the sampled data, in response to the request. In some aspects, the transceiver may be further configured to receive, from the BS, the set of received signal measurements as input data, wherein the set of received signal measurements comprises historical measurements of a plurality of transmission beams associated with the BS and historical signal strength measurements of downlink specific reference signals carried in the plurality of transmission beams. In some aspects, the processor may be further configured to measure, a plurality of transmission beams associated with the BS during a first time period, obtain a RSRP measurement of a downlink specific reference signal carried in each of the plurality of transmission beams, select one of the plurality of transmission beams carrying a downlink specific reference signal with a highest RSRP measurement as output data, and provide a feedback pairing comprising the input data and the output data as the sampled data. In some aspects, the request includes a request for the UE to perform one or more signal measurements at a particular time instance during the first time period, in which the first subband includes a plurality of PDCCHs multiplexed in at least one of time or frequency in a first portion of the first time period. In some aspects, the transceiver configured to receive the request may be further configured to receive the request in one or more PDCCHs of the plurality of PDCCHs. In other aspects, the request includes a request for the UE to perform a plurality of periodical signal measurements during the first time period. In some instances, the transceiver configured to receive the request may be further configured to receive the request in a RRC signal. In some aspects, the transceiver may be further configured to communicate, with the BS over a plurality of periodic intervals during a second time period greater than the first time period, the sampled data with the plurality of periodical signal measurements, in response to the request.

In some aspects, the request includes a request for the UE to communicate a first proportion of the sampled data that corresponds to a prediction error of the machine learning-based network. In some instances, the transceiver configured to receive the request may be further configured to receive the request in a RRC signal. In some aspects, the transceiver is further configured to communicate, with the BS, the report comprising the first proportion of the sampled data that corresponds to the prediction error of the machine learning-based network. In some aspects, the request includes a request for the UE to communicate a second proportion of the sampled data that corresponds to a correct prediction of the machine learning-based network. In somec instances, the transceiver may be further configured to communicate, with the BS, the report comprising the second proportion of the sampled data that corresponds to the correct prediction of the machine learning-based network.

In some aspects, the request includes a request for the UE to communicate a subset of sampled data comprising up to a predetermined number of signal measurements that corresponds to a correct prediction of the machine learning-based network when no sampled data corresponding to a prediction error of the machine learning-based network is present in the sampled data. In some instances, the transceiver configured to receive the request may be further configured to receive the request in a RRC signal. In some aspects, the processor may be further configured to determine that no sampled data corresponding to a prediction error of the machine learning-based network is present in the sampled data. In some aspects, the transceiver may be further configured to communicate, with the BS, the report comprising the subset of sampled data corresponding to a correct prediction of the machine learning-based network, the subset of sampled data comprising a number of signal measurements up to the predetermined number of signal measurements.

In some aspects, the request includes a request for the UE to measure sampled data for a predetermined number of time instances in a second time period subsequent to the first time period when sampled data corresponding to a prediction error of the machine learning-based network is present in the sampled data.

In some aspects, the transceiver may be further configured to encode the sampled data into encoded sampled data during a time period of reporting within the first time period, and, communicate, with the BS during the time period of reporting, the encoded sampled data.

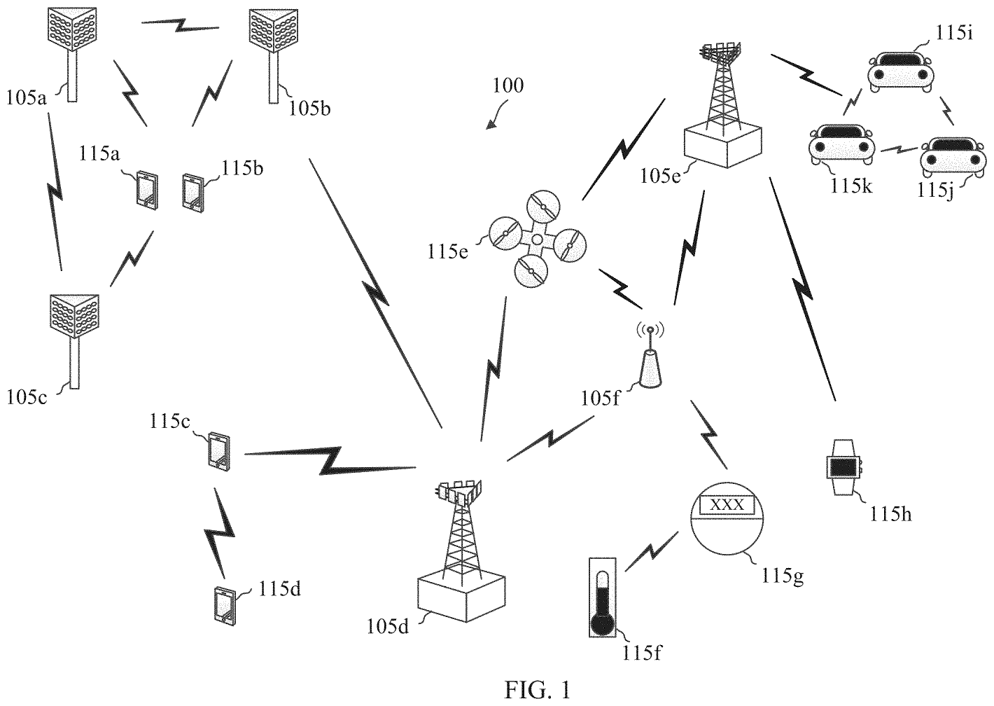

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and LE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (e.g., PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

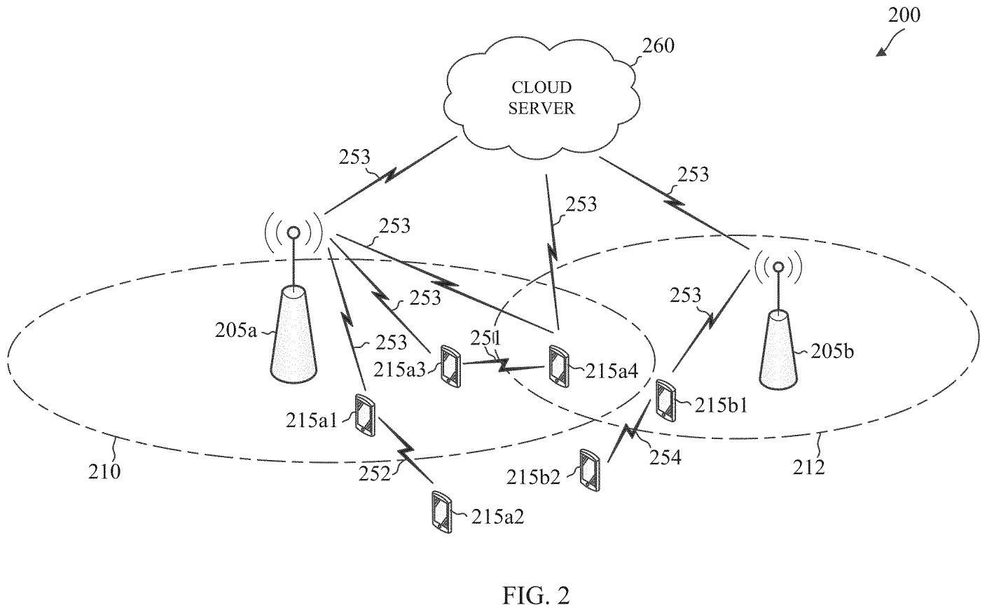

In some aspects, the network 100 may support sidelink communication among the UEs 115 over a shared radio frequency band (e.g., in a shared spectrum or an unlicensed spectrum). In some aspects, the UEs 115 may communicate with each other over a 2.4 GHz unlicensed band, which may be shared by multiple network operating entities using various radio access technologies (RATs) such as NR-U, WiFi, and/or licensed-assisted access (LAA) as shown in FIG. 2.

In some aspects, the network 100 may be implemented with artificial intelligence to assist cellular network performance by implementing machine learning (ML) algorithms to predict certain properties and/or operations within the network 100. These ML algorithms may include neural networks that are implemented at different types of nodes within the network 100. For example, the neural networks may be implemented at a single node (e.g., UEs 115, BSs 115) or may be distributed over multiple nodes. The ML algorithms may be implemented to assist with different functions and/or modules among the nodes of the network 100.

FIG. 2 illustrates a wireless communication network 200 that provisions for user equipment reporting according to some aspects of the present disclosure. The network 200 may correspond to a portion of the network 100. FIG. 2 illustrates two BSs 205 (shown as 205a and 205b) and six UEs 215 (shown as 215a1, 215a2, 215a3, 215a4, 215b1, and 215b2) for purposes of simplicity of discussion, though it will be recognized that embodiments of the present disclosure may scale to any suitable number of UEs 215 (e.g., the about 2, 3, 4, 5, 7 or more) and/or BSs 205 (e.g., the about 1, 3 or more). The BS 205 and the UEs 215 may be similar to the BSs 105 and the UEs 115, respectively. The BSs 205 and the UEs 215 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

The BS 205a and the UEs 215a1-215a4 may be operated by a first network operating entity. The BS 205b and the UEs 215b1-215b2 may be operated by a second network operating entity. In some aspects, the first network operating entity may utilize a same RAT as the second network operating entity. For instance, the BS 205a and the UEs 215a1-215a4 of the first network operating entity and the BS 205b and the UEs 215b1-215b2 of the second network operating entity are NR-U devices. In some other aspects, the first network operating entity may utilize a different RAT than the second network operating entity. For instance, the BS 205a and the UEs 215a1-215a4 of the first network operating entity may utilize NR-U technology while the BS 205b and the UEs 215b1-215b2 of the second network operating entity may utilize WiFi or LAA technology.

The network 200 also illustrates a cloud server 260 that may be operated independent of the first network operating entity and the second network operating entity. In some aspects, the cloud server 260 may be operated in conjunction with one or more of the first or second network operating entities. The cloud server 260 may be a centralized node in communication with one or more BSs 205 and/or UEs 215 via communication links 253.

In the network 200, some of the UEs 215a1-215a4 may communicate with each other in peer-to-peer communications. For example, the UE 215a1 may communicate with the UE 215a2 over a sidelink 252, the UE 215a3 may communicate with the UE 215a4 over another sidelink 251, and the UE 215b1 may communicate with the UE 215b2 over yet another sidelink 254. The sidelinks 251, 252, and 254 are unicast bidirectional links. Some of the UEs 215 may also communicate with the BS 205a or the BS 205b in a UL direction and/or a DL direction via communication links 253. For instance, the UE 215a1, 215a3, and 215a4 are within a coverage area 210 of the BS 205a, and thus may be in communication with the BS 205a. The UE 215a2 is outside the coverage area 210, and thus may not be in direct communication with the BS 205a. In some instances, the UE 215a1 may operate as a relay for the UE 215a2 to reach the BS 205a. Similarly, the UE 215b1 is within a coverage area 212 of the BS 205b, and thus may be in communication with the BS 205b and may operate as a relay for the UE 215b2 to reach the BS 205b. In some aspects, some of the UEs 215 are associated with vehicles (e.g., similar to the UEs 115i-k) and the communications over the sidelinks 251, 252, and 254 may be C-V2X communications. C-V2X communications may refer to communications between vehicles and any other wireless communication devices in a cellular network.

In various aspects, the network 200 may be implemented with artificial intelligence to assist cellular network performance by implementing machine learning (ML) algorithms to predict certain properties and/or operations within the network 200. These ML algorithms may include neural networks that are implemented at different types of nodes within the network 200. For example, the neural networks may be implemented at a single node (e.g., UEs 215, BSs 215) or may be distributed over multiple nodes. The ML algorithms may be implemented to assist with different functions and/or modules among the nodes of the network 200.

In some aspects, each node (e.g., UEs 215, BSs 205 and/or cloud server 260) may be implemented with one or more ML algorithms. The ML algorithms may interact with different layers within the node. The ML algorithms may interact with one of the PHY layer, the MAC layer or upper layers (e.g., application layer) in some instances, or with multiple layers in other instances. For example, a node (e.g., the UEs 215) may include a ML module adapted for low-density parity check (LDPC) decoding at the PHY layer. In another example, a node (e.g., the BSs 205, cloud server 260) may include a ML Module for CSI prediction and/or TCI selection at the PHY and MAC layers. In another example, a node (e.g., BS 205) may include a ML Module for MU scheduling taking account for package latency and/or priority at the PHY layer, the MAC layer and the upper layers. These ML algorithms may involve various ML-related data transfers between different layers of the different nodes (e.g., the UEs 215, the BSs 205, the cloud server 260). The ML algorithms may be trained with training datasets that are produced through periodic and/or aperiodic data collection at the UEs 215. In various aspects, measurement data collection serves as input to the ML modules. The operation of these ML algorithms at the different nodes may be used for ML model parameter transfer and/or update. The ML model framework within the network 200 has the capability to communicate feedback signals and/or reports between the different nodes (e.g., between UEs 215 and BSs 205). In various aspects, the UE 215a1 may feed back channel measurements that are indicative of the ML model prediction accuracy. For example, the measurement data collection by the UE 215a1 that is then sent with a report to the BS 205a and/or the cloud server 260 may indicate that the ML model is producing prediction errors, thus indicative that the ML model requires updating. In some aspects, the ML modules may provide intermediate data transfer between the different nodes (e.g. to facilitate training with stochastic gradient decent and backpropagation for a distributed ML algorithm).

In some aspects, a ML module is distributed in the BSs 205, the UEs 215 and the cloud server 260, which is adapted for BS-side beam prediction based on signal measurements obtained by the UEs 215. The UEs 215 may be adapted to collect channel measurements with the UE PHY layer, pack the channel measurement data in the UE application layer, and communicate the channel measurement data with BS-side application layer of the BSs 205 and the server-side application layer of the cloud server 260. The BS-side application layer of the BSs 205 may be adapted to receive the channel measurement data from the UEs 215, pass the channel measurement data as input to one or more neural networks operating at one or more of the BSs 205 or the cloud server 260, forward propagate the neural network, pass the output of the neural network for a beam selection model, change one or more parameters of the beam selection model, as well as receiving neural network parameter updates from the cloud server 260. The server-side application layer of the cloud server 260 may be adapted to receive the channel measurement data from the UEs 215, train the neural network with an existing training dataset and/or an updated training dataset, send a neural network update to the BS-side application layer of the BSs 205.

In some examples, the BS 205a transmits, to UEs 215a1, 215a3 and 215a4, a neural network, such as a machine learning-based network, for predicting a best performing transmission beam from the BS 205a to monitor a downlink specific reference signal, such as the SSB. The input to the neural network can be the previous 10 signal measurements of the BS 205a transmission beam monitored and the corresponding measured signal strength (e.g., RSRP) of the SSB. The output of the neural network may include a prediction of the best performing transmission beam from the BS 205a. The neural network may be trained offline from previously collected channel measurement data at the BS 205a or at the cloud server 260.

From time to time, each UE (e.g., UE 215a1, UE 215a3, UE 215a4) can gather the input data from the BS 205a and scan over all transmission beams for detecting the best performing SSB beam to determine the output data from the neural network (e.g., the machine learning-based network), and communicate feedback pair (e.g., input data, output data) as sampled data to the BS 205a for updating of the neural network.

In some of the sampled data, the measured best performing SSB beam may not be the same as the predicted best performing SSB beam using the neural network, which indicates a prediction error of the neural network. For other sampled data, the neural network prediction may be correct. When the UEs 215 determine the neural network prediction is not correct, there may not be sufficient time for the UEs 215 to obtain additional sampled data. For example, the UEs 215 may not be able to measure additional SSB beams other than the predicted SSB beam. However, the following time instance may produce similar sampled data. If the UEs 215 measure the channel during the following time instance and collect the following sampled data, there is a higher likelihood that the UEs 215 are collecting sampled data with neural network prediction errors.

The present disclosure provides techniques for the UE to feed back sampled data of the channel properties that correspond to an incorrect prediction (or generally referred to as “a prediction error” herein) to the BS to serve as more insightful data that helps improve the ML algorithms. To update the neural network(s), it may be more valuable to feed back the sampled data when a prediction error occurs. In various aspects, the UE is configured to feed back a subset of the sampled data that corresponds to a correct prediction to the BS since this sampled data may not be as indicative as to how to improve the ML algorithms other than to reassure that the ML algorithms are performing as expected.

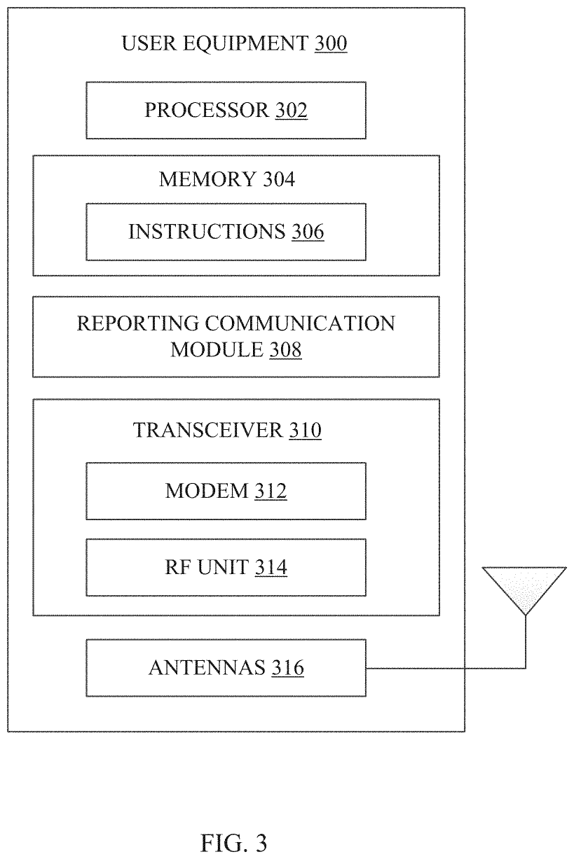

FIG. 3 is a block diagram of an exemplary UE 300 according to some aspects of the present disclosure. The UE 300 may be a UE 115 discussed above in FIG. 1 or a UE 215 discussed above in FIG. 2. As shown, the UE 300 may include a processor 302, a memory 304, a reporting communication module 308, a transceiver 310 including a modem subsystem 312 and a radio frequency (RF) unit 314, and one or more antennas 316. These elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to the UEs 115 in connection with aspects of the present disclosure, for example, aspects of FIGS. 1, 2, and 5-9. Instructions 306 may also be referred to as program code. The program code may be for causing a wireless communication device to perform these operations, for example by causing one or more processors (such as processor 302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The reporting communication module 308 may be implemented via hardware, software, or combinations thereof. For example, the reporting communication module 308 may be implemented as a processor, circuit, and/or instructions 306 stored in the memory 304 and executed by the processor 302. In some instances, the reporting communication module 308 can be integrated within the modem subsystem 312. For example, the reporting communication module 308 can be implemented by a combination of software components (e.g., executed by a DSP or a general processor) and hardware components (e.g., logic gates and circuitry) within the modem subsystem 312.

The reporting communication module 308 may be used for various aspects of the present disclosure, for example, aspects of FIGS. 1, 2, and 5-9. For instance, the reporting communication module 308 may coordinate with the processor 302 to apply a machine learning-based network to a set of received signal measurements and determine whether an output of the machine learning-based network fails to satisfy one or more criteria. In some aspects, the reporting communication module 308 may determine that the output of the machine learning-based network corresponds to a prediction error based on a comparison between at least one signal measurement in the set of received signal measurements and a signal measurement obtained by the UE.

In some aspects, the reporting communication module 308 may coordinate with the transceiver 310 to communicate, with a BS (e.g., BSs 105, 205 and/or 400), a report when the output of the machine learning-based network fails to satisfy the one or more criteria. In some aspects, the reporting communication module 308, in coordination with the transceiver 310, may receive a predetermined threshold from the BS for use with the machine learning-based network. In some aspects, the reporting communication module 308, in coordination with the processor 302, may be further configured to determine whether the output of the machine learning-based network fails to satisfy the one or more criteria may be further configured to determine that the output of the machine learning-based network fails to satisfy the one or more criteria based on the predetermined threshold. In some aspects, the reporting communication module 308 may be further configured to determine whether a first signal measurement in the set of received signal measurements is greater than the predetermined threshold, and determine that the output of the machine learning-based network corresponds to a prediction error when the first signal measurement in the set of received signal measurements is not greater than the predetermined threshold. In some aspects, the predetermined threshold corresponds to a target reference signal received power (RSRP) value for a downlink specific reference signal. In some aspects, the downlink specific reference signal includes a synchronization signal block (e.g., SSB). In other aspects, the downlink specific reference signal comprises a channel state information reference signal (e.g., CSI-RS).

In some aspects, the reporting communication module 308, in coordination with the transceiver 310, may receive, in a first subband of a plurality of subbands, a request for the UE 300 to measure sampled ground-truth data. In some instances, the reporting communication module 308 is further configured to obtain the sampled ground-truth data in response to the request. In some aspects, the reporting communication module 308 may be further configured to determine that the output of the machine learning-based network corresponds to a prediction error based on a comparison between at least one signal measurement in the set of received signal measurements and the sampled ground-truth data. In some aspects, the request includes a request for measurement of the sampled ground-truth data by the UE 300 at a particular time instance during a first time period, in which the first subband includes a plurality of physical downlink control channels (e.g., PDCCHs, or enhanced PDCCHs (ePDCCHs)) multiplexed in at least one of time or frequency in a first portion of the first time period. In some instances, the reporting communication module 308, in coordination with the transceiver 310, may be further configured to receive the request in one or more PDCCHs of the plurality of PDCCHs. In some aspects, the request includes a request for the UE 300 to perform a plurality of periodical signal measurements of the sampled ground-truth data.

In some aspects, the reporting communication module 308, in coordination with the transceiver 310, may receive, in a first subband of a plurality of subbands, a request to communicate sampled data with the BS. In some instances, the reporting communication module 308, in coordination with the transceiver 310, may communicate, with the BS, the report with the sampled data, in response to the request. In some aspects, the reporting communication module 308, in coordination with the transceiver 310, may receive, from the BS, the set of received signal measurements as input data, wherein the set of received signal measurements comprises historical measurements of a plurality of transmission beams associated with the BS and historical signal strength measurements of downlink specific reference signals carried in the plurality of transmission beams. In some aspects, the reporting communication module 308 may be further configured to measure, a plurality of transmission beams associated with the BS during a first time period, obtain a RSRP measurement of a downlink specific reference signal carried in each of the plurality of transmission beams, select one of the plurality of transmission beams carrying a downlink specific reference signal with a highest RSRP measurement as output data, and provide a feedback pairing that includes the input data and the output data as the sampled data. In some aspects, the request includes a request for the UE 300 to perform one or more signal measurements at a particular time instance during the first time period. In other aspects, the request includes a request for the UE 300 to perform a plurality of periodical signal measurements during the first time period. In some aspects, the reporting communication module 308, in coordination with the transceiver 310, may be further configured to communicate, with the BS over a plurality of periodic intervals during a second time period greater than the first time period, the sampled data with the plurality of periodical signal measurements, in response to the request.

In some aspects, the request send from the BS (e.g., BSs 105, 205 and/or 400) includes a request for the UE 300 to communicate a first proportion of the sampled data that corresponds to a prediction error of the machine learning-based network. In some instances, the reporting communication module 308, in coordination with the transceiver 310, may communicate, with the BS, the report including the first proportion of the sampled data that corresponds to the prediction error of the machine learning-based network. In some aspects, the request includes a request for the UE 300 to communicate a second proportion of the sampled data that corresponds to a correct prediction of the machine learning-based network. In some instances, the reporting communication module 308, in coordination with the transceiver 310, may communicate, with the BS, the report including the second proportion of the sampled data that corresponds to the correct prediction of the machine learning-based network.

In some aspects, the request includes a request for the UE 300 to communicate a subset of sampled data comprising up to a predetermined number of signal measurements that corresponds to a correct prediction of the machine learning-based network when no sampled data corresponding to a prediction error of the machine learning-based network is present in the sampled data. In some instances, the reporting communication module 308 may be further configured to determine that no sampled data corresponding to a prediction error of the machine learning-based network is present in the sampled data. In some aspects, the reporting communication module 308, in coordination with the transceiver 310, may communicate, with the BS, the report including the subset of sampled data corresponding to a correct prediction of the machine learning-based network. In some aspects, the subset of sampled data includes a number of signal measurements up to the predetermined number of signal measurements.

In some aspects, the reporting communication module 308 may be further configured to measure sampled data for a predetermined number of time instances in a second time period subsequent to the first time period when sampled data corresponding to a prediction error of the machine learning-based network is present in the sampled data.

As shown, the transceiver 310 may include the modem subsystem 312 and the RF unit 314. The transceiver 310 can be configured to communicate bi-directionally with other devices, such as the BSs 105. The modem subsystem 312 may be configured to modulate and/or encode the data from the memory 304 and/or the reporting communication module 308 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 314 may be configured to process (e.g., perform analog to digital conversion or digital to analog conversion, etc.) modulated/encoded data (e.g., uplink data, synchronization signal, SSBs) from the modem subsystem 312 (on outbound transmissions) or of transmissions originating from another source such as a UE 115 or a BS 105. The RF unit 314 may be further configured to perform analog beamforming in conjunction with the digital beamforming. Although shown as integrated together in transceiver 310, the modem subsystem 312 and the RF unit 314 may be separate devices that are coupled together at the UE 115 to enable the UE 115 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., reference signal, synchronization signal, SSBs) to the reporting communication module 308 for processing. The antennas 316 may include multiple antennas of similar or different designs in order to sustain multiple transmission links. The RF unit 314 may configure the antennas 316. In some aspects, the RF unit 314 may include various RF components, such as local oscillator (LO), analog filters, and/or mixers. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission and/or reception requirements at the UE 300.

In some aspects, the transceiver 310 is configured to receive a radio resource control (e.g., RRC) signal containing a request for the UE 300 to perform channel measurements. In some aspects, the transceiver 310 is configured to communicate, with the BS, the report when the output of the machine learning-based network fails to satisfy the one or more criteria, for example, by coordinating with the reporting communication module 308. In some instances, the transceiver 310 is configured to communicate the report may be further configured to transmit, to the BS in a first subband of a plurality of subbands, sampled data for updating the machine learning-based network. In some aspects, the first subband includes a plurality of physical uplink shared channels (e.g., PUSCHs) multiplexed in at least one of time or frequency in a first portion of a first time period, and the transceiver configured to transmit the sampled data may be further configured to transmit the sampled data in one or more PUSCHs of the plurality of PUSCHs. In some aspects, the sampled data includes a feedback pairing of at least one signal measurement in the set of received signal measurements and the output of the machine learning-based network associated with the at least one signal measurement. In some aspects, the transceiver 310 may be further configured to encode the sampled data into encoded sampled data during a time period of reporting within the first time period, and communicate, with the BS during the time period of reporting, the encoded sampled data.

In an aspect, the UE 300 can include multiple transceivers 310 implementing different RATs (e.g., NR and LTE). In an aspect, the UE 300 can include a single transceiver 310 implementing multiple RATs (e.g., NR and LTE). In an aspect, the transceiver 310 can include various components, where different combinations of components can implement different RATs.

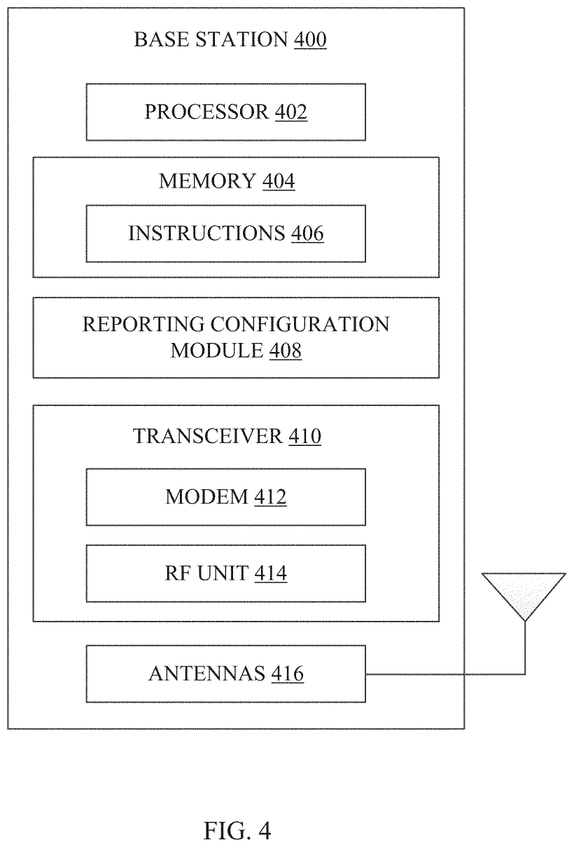

FIG. 4 is a block diagram of an exemplary BS 400 according to some aspects of the present disclosure. The BS 400 may be a BS 105 in the network 100 as discussed above in FIG. 1 or a BS 205 in the network 200 as discussed above in FIG. 2. As shown, the BS 400 may include a processor 402, a memory 404, a reporting configuration module 408, a transceiver 410 including a modem subsystem 412 and a RF unit 414, and one or more antennas 416. These elements may be in direct or indirect communication with each other, for example via one or more buses.

The processor 402 may have various features as a specific-type processor. For example, these may include a CPU, a DSP, an ASIC, a controller, a FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 1, 2, and 5-9. Instructions 406 may also be referred to as code, which may be interpreted broadly to include any type of computer-readable statement(s) as discussed above with respect to FIG. 3.

The reporting configuration module 408 may be implemented via hardware, software, or combinations thereof. For example, the reporting configuration module 408 may be implemented as a processor, circuit, and/or instructions 406 stored in the memory 404 and executed by the processor 402. In some instances, the reporting configuration module 408 can be integrated within the modem subsystem 412. For example, the reporting configuration module 408 can be implemented by a combination of software components (e.g., executed by a DSP or a general processor) and hardware components (e.g., logic gates and circuitry) within the modem subsystem 412.

The reporting configuration module 408 may be used for various aspects of the present disclosure, for example, aspects of FIGS. 1, 2, and 5-9. For instance, the reporting configuration module 408, in coordination with the transceiver 410, is configured to communicate, with one or more UEs (e.g., the UEs 115, 215, and/or 300), a first configuration for a machine learning-based network, receive, from a first UE, (e.g., the UE 300) of the one or more UEs, a report associated with a prediction error in the machine learning-based network, and communicating, with the UE 300, a second configuration for the machine learning-based network based on the received report. In some aspects, the second configuration may represent an update to the machine learning-based network. In some aspects, the first configuration sent to the UE 300 may include a set of signal measurements. The set of signal measurements can include historical measurements of a plurality of transmission beams associated with the BS and historical signal strength measurements of downlink specific reference signals carried in the plurality of transmission beams.

In some aspects, the reporting configuration module 408, in coordination with the transceiver 410, is configured to transmit, to the UE 300 in a first subband of a plurality of subbands, a request for the UE 300 to communicate sampled data with the BS. The transceiver 410 may be configured to transmit the request in one or more PDCCHs of the plurality of PDCCHs. In some instances, the transceiver is configured to receive the report with the sampled data, in response to the request. The sampled data may be received by the BS 400 at a particular time instance in some embodiments, or over a plurality of over a plurality of periodic intervals during a period of periodic reporting that is greater than a period designated for obtaining the measurements.

In some aspects, the reporting configuration module 408, in coordination with the transceiver 410, is configured to transmit a predetermined threshold for use by the UE 300 with the machine learning-based network in the first configuration. The prediction error in the machine learning-based network may be based at least on a comparison between the predetermined threshold and a signal measurement of a corresponding transmission beam. In other aspects, the reporting configuration module 408, in coordination with the transceiver 410, is configured to transmit a request for the UE 300 to communicate a subset of sampled data comprising up to a predetermined number of signal measurements that corresponds to a correct prediction of the machine learning-based network when no sampled data corresponding to a prediction error of the machine learning-based network is present in the sampled data.

In some aspects, the reporting configuration module 408, in coordination with the transceiver 410, is configured to transmit a request for the UE 300 to communicate a first proportion of the sampled data that corresponds to a prediction error of the machine learning-based network. In other aspects, the reporting configuration module 408, in coordination with the transceiver 410, is configured to transmit a request for the UE 300 to communicate a second proportion of the sampled data that corresponds to a correct prediction of the machine learning-based network.

As shown, the transceiver 410 may include the modem subsystem 412 and the RF unit 414. The transceiver 410 can be configured to communicate bi-directionally with other devices, such as the UEs 115 and/or 500 and/or another core network element. The modem subsystem 412 may be configured to modulate and/or encode data according to a MCS, e.g., a LDPC coding scheme, a turbo coding scheme, a convolutional coding scheme, a polar coding scheme, a digital beamforming scheme, etc. The RF unit 414 may be configured to process (e.g., perform analog to digital conversion or digital to analog conversion, etc.) modulated/encoded data (e.g., PDCCH, PDSCH, SSBs, UE reporting configuration, machine learning-based network configuration) from the modem subsystem 412 (on outbound transmissions) or of transmissions originating from another source such as a UE 115 and/or UE 500. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 105 to enable the BS 105 to communicate with other devices.

The RF unit 414 may provide the modulated and/or processed data, e.g. data packets (or, more generally, data messages that may contain one or more data packets and other information), to the antennas 416 for transmission to one or more other devices. This may include, for example, transmission of information to complete attachment to a network and communication with a camped UE 115 or 500 according to some aspects of the present disclosure. The antennas 416 may further receive data messages transmitted from other devices and provide the received data messages for processing and/or demodulation at the transceiver 410. The transceiver 410 may provide the demodulated and decoded data (e.g., CBR reports and/or CR reports) to the reporting configuration module 408 for processing. The antennas 416 may include multiple antennas of similar or different designs in order to sustain multiple transmission links.

In an aspect, the BS 400 can include multiple transceivers 410 implementing different RATs (e.g., NR and LTE). In an aspect, the BS 400 can include a single transceiver 410 implementing multiple RATs (e.g., NR and LTE). In an aspect, the transceiver 410 can include various components, where different combinations of components can implement different RATs.

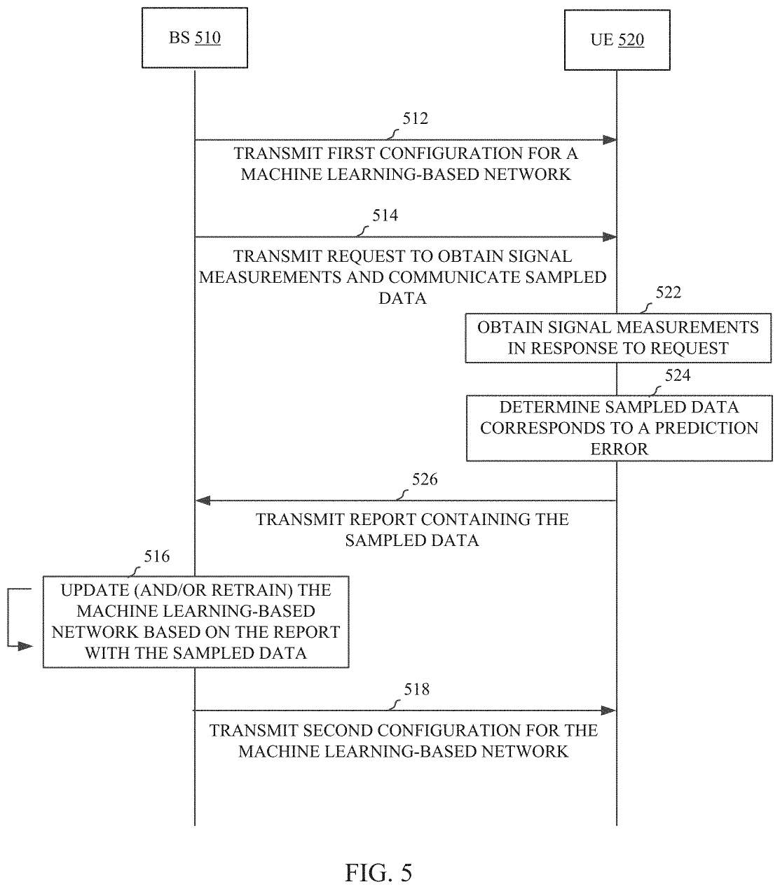

FIG. 5 is a simplified diagram of an example frame exchange 500 between a user equipment and a base station for user equipment reporting for updating a machine learning network according to some aspects of the present disclosure. The frame exchange 500 may be implemented between a BS 510 and a UE 520. The BS 510 may be similar to the BS 105, 205, 400 and the UE 520 may be similar to the UE 115, 215, 300. Additionally, the BS 510 and the UE 520 may operate in a network such as the network 100 or 200. As illustrated, the frame exchange 500 includes a number of enumerated actions, but embodiments of the frame exchange 500 may include additional actions before, after, and in between the enumerated actions. In some aspects, one or more of the enumerated actions may be omitted or performed in a different order.

At action 512, the BS 510 transmits a first configuration for a machine learning-based network. The first configuration may include one or more reference signals (e.g., SSB, CSI) configured for the UE 520. The UE may receive the first configuration of the machine learning-based network from the BS 510. In some aspects, the UE 520 receives, from the BS 510, the set of received signal measurements as input data, in which the set of received signal measurements includes historical measurements of a plurality of transmission beams associated with the BS and historical signal strength measurements of downlink specific reference signals carried in the plurality of transmission beams.

At action 514, the BS 510 transmits a request for the UE 520 to obtain signal measurements and communicate sampled data back to the BS 510. In some aspects, the request is transmitted via a RRC signal. In other aspects, the request from the BS 510 includes a request for the UE 520 to perform a plurality of periodical signal measurements during the first time period.

At action 522, the UE 520 may perform one or more measurements of the one or more reference signals. The UE 520 may, for example, measure RSRP and/or CQI of one or more transmission beams of the BS 510. In some aspects, the UE 520 may measure, a plurality of transmission beams associated with the BS 510 during a first time period, obtain a RSRP measurement of a downlink specific reference signal carried in each of the plurality of transmission beams, select one of the plurality of transmission beams carrying a downlink specific reference signal with a highest RSRP measurement as output data, and provide a feedback pairing that includes the input data and the output data as the sampled data.

At action 524, the UE 520 determines that the sampled data corresponds to a prediction error of the machine learning-based network. The UE 520 may apply the machine learning-based network with the first configuration to a set of received signal measurements and determine whether an output of the machine learning-based network fails to satisfy one or more criteria. In some aspects, the UE 520 may determine that the output of the machine learning-based network corresponds to a prediction error based on a comparison between at least one signal measurement in the set of received signal measurements and a signal measurement obtained by the UE 520.

At action 526, the UE 520 may transmit a report in response to the request (e.g., 514) from the BS 510. The UE 520 may transmit the report to include one or more of the signal measurements that correspond to both a prediction error and a correct prediction. In some aspects, the BS 510 may request to receive sampled data that corresponds exclusively to the prediction error. In some examples, the report may include at least one of RSRP or CQI. In some aspects, the report is multiplexed between at least one of RSRP or CQI or other UL control information (UCI) when configured PUCCH resources of the RSRP, or CQI, or the other UCI overlap. In some aspects, the BS 520 transmits a CSI report. In some aspects, the sampled data includes a feedback pairing of at least one signal measurement in the set of received signal measurements and the output of the machine learning-based network associated with the at least one signal measurement.

At action 516, the BS 510 updates and/or retrains the machine learning-based network based on the report with the sampled data. In some aspects, the BS 510 obtains a second configuration for the machine learning-based network.

At action 518, the BS 510 communicates with the UE 520 an updated machine learning-based network by transmitting the second configuration for the machine learning-based network.

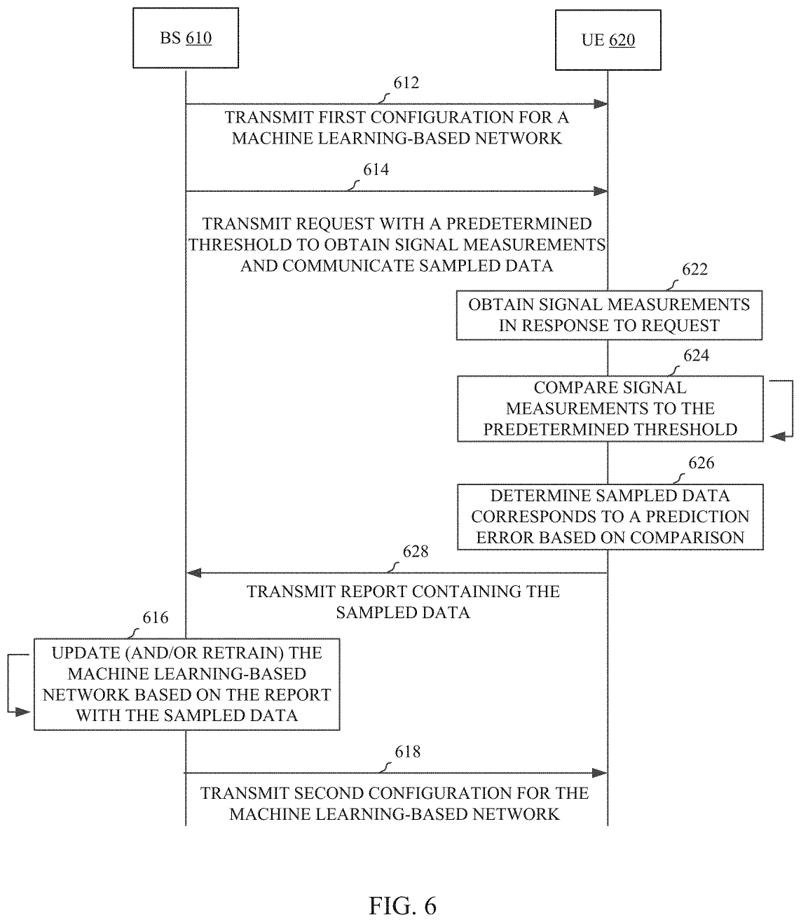

FIG. 6 is a simplified diagram of another example frame exchange 600 between a user equipment and a base station for user equipment reporting for updating a machine learning network according to some aspects of the present disclosure. The frame exchange 600 may be implemented between a BS 610 and a UE 620. The BS 610 may be similar to the BS 105, 205, 400 and the UE 620 may be similar to the UE 115, 215, 300. Additionally, the BS 610 and the UE 620 may operate in a network such as the network 100 or 200. As illustrated, the frame exchange 600 includes a number of enumerated actions, but embodiments of the frame exchange 600 may include additional actions before, after, and in between the enumerated actions. In some aspects, one or more of the enumerated actions may be omitted or performed in a different order.

At action 612, the BS 610 transmits a first configuration for a machine learning-based network. The first configuration may include one or more reference signals (e.g., SSB, CSI) configured for the UE 620. The UE may receive the first configuration of the machine learning-based network from the BS 610. In some aspects, the UE 620 receives, from the BS 610, the set of received signal measurements as input data, in which the set of received signal measurements includes historical measurements of a plurality of transmission beams associated with the BS and historical signal strength measurements of downlink specific reference signals carried in the plurality of transmission beams.

At action 614, the BS 610 transmits a request for the UE 620 to obtain signal measurements and communicate sampled data back to the BS 610. In some aspects, the BS 610 transmits a predetermined threshold with the request for use with the machine learning-based network. In some aspects, the request is transmitted via a RRC signal.

At action 622, the UE 620 may perform one or more measurements of the one or more reference signals. The UE 620 may, for example, measure RSRP and/or CQI of one or more transmission beams of the BS 610. In some aspects, the UE 620 may measure, a plurality of transmission beams associated with the BS 610 during a first time period, obtain a RSRP measurement of a downlink specific reference signal carried in each of the plurality of transmission beams, select one of the plurality of transmission beams carrying a downlink specific reference signal with a highest RSRP measurement as output data, and provide a feedback pairing that includes the input data and the output data as the sampled data.

At action 624, the UE 620 compares one or more of the obtained signal measurements to the predetermined threshold. For example, the UE 620 may determine whether a first signal measurement in the set of received signal measurements is greater than the predetermined threshold, and determine that the output of the machine learning-based network corresponds to a prediction error when the first signal measurement in the set of received signal measurements is not greater than the predetermined threshold. In some aspects, the predetermined threshold corresponds to a target reference signal received power (RSRP) value for a downlink specific reference signal.

At action 626, the UE 620 determines that the output of the machine learning-based network fails to satisfy the one or more criteria by determining that the sampled data corresponds to a prediction error of the machine learning-based network based on the predetermined threshold the UE 620. The UE 620 may apply the machine learning-based network with the first configuration to a set of received signal measurements and determine whether an output of the machine learning-based network fails to satisfy one or more criteria. In some aspects, the UE 620 may determine that the output of the machine learning-based network corresponds to a prediction error based on a comparison between at least one signal measurement in the set of received signal measurements and a signal measurement obtained by the UE 620.

At action 628, the UE 620 may transmit a report in response to the request (e.g., 614) from the BS 610. The UE 620 may transmit the report to include one or more of the signal measurements that correspond to both a prediction error and a correct prediction. In some aspects, the BS 610 may request to receive sampled data that corresponds exclusively to the prediction error. In some examples, the report may include at least one of RSRP or CQI. In some aspects, the report is multiplexed between at least one of RSRP or CQI or other UL control information (UCI) when configured PUCCH resources of the RSRP, or CQI, or the other UCI overlap. In some aspects, the BS 620 transmits a CSI report. In some aspects, the sampled data includes a feedback pairing of at least one signal measurement in the set of received signal measurements and the output of the machine learning-based network associated with the at least one signal measurement.

At action 616, the BS 610 updates and/or retrains the machine learning-based network based on the report with the sampled data. In some aspects, the BS 610 obtains a second configuration for the machine learning-based network.

At action 618, the BS 610 communicates with the UE 620 an updated machine learning-based network by transmitting the second configuration for the machine learning-based network.

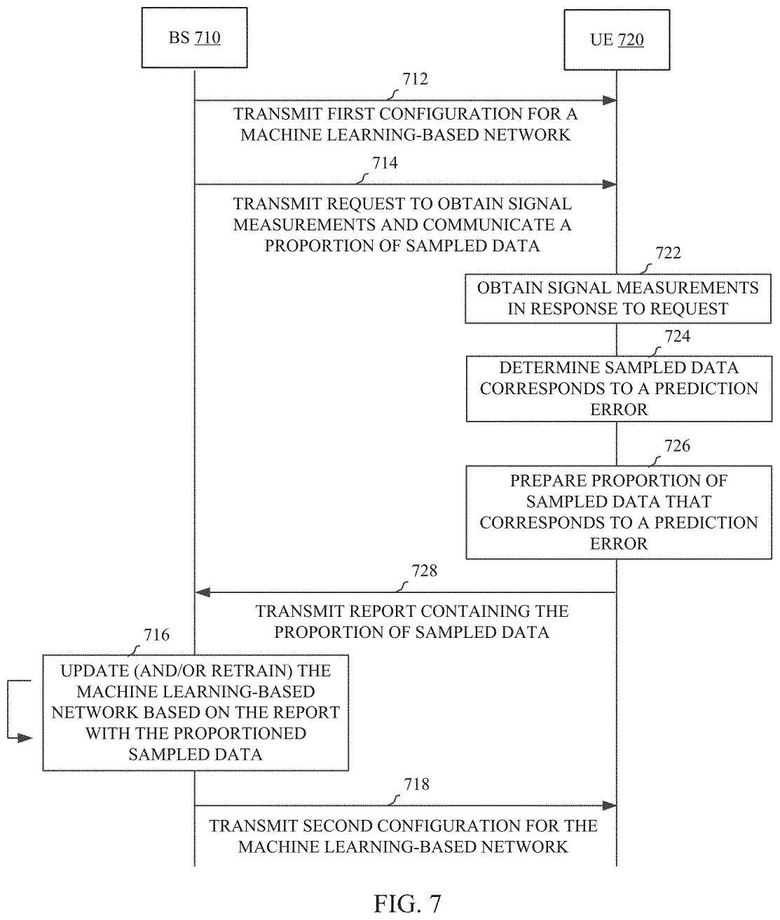

FIG. 7 is a simplified diagram of another example frame exchange 700 between a user equipment and a base station for user equipment reporting for updating a machine learning network according to some aspects of the present disclosure. The frame exchange 700 may be implemented between a BS 710 and a UE 720. The BS 710 may be similar to the BS 105, 205, 400 and the UE 720 may be similar to the UE 115, 215, 300. Additionally, the BS 710 and the UE 720 may operate in a network such as the network 100 or 200. As illustrated, the frame exchange 700 includes a number of enumerated actions, but embodiments of the frame exchange 700 may include additional actions before, after, and in between the enumerated actions. In some aspects, one or more of the enumerated actions may be omitted or performed in a different order.

At action 712, the BS 710 transmits a first configuration for a machine learning-based network. The first configuration may include one or more reference signals (e.g., SSB, CSI) configured for the UE 720. The UE may receive the first configuration of the machine learning-based network from the BS 710. In some aspects, the UE 720 receives, from the BS 710, the set of received signal measurements as input data, in which the set of received signal measurements includes historical measurements of a plurality of transmission beams associated with the BS and historical signal strength measurements of downlink specific reference signals carried in the plurality of transmission beams.

At action 714, the BS 710 transmits a request for the UE 720 to obtain signal measurements and communicate sampled data back to the BS 710. In some aspects, the request includes a request for the UE 720 to communicate a first proportion of the sampled data that corresponds to a prediction error of the machine learning-based network. In other aspects, the request includes a request for the UE 720 to communicate a second proportion of the sampled data that corresponds to a correct prediction of the machine learning-based network. In some aspects, the request is transmitted via a RRC signal. In other aspects, the request from the BS 710 includes a request for the UE 720 to perform a plurality of periodical signal measurements during the first time period.

At action 722, the UE 720 may perform one or more measurements of the one or more reference signals. The UE 720 may, for example, measure RSRP and/or CQI of one or more transmission beams of the BS 710. In some aspects, the UE 720 may measure, a plurality of transmission beams associated with the BS 710 during a first time period, obtain a RSRP measurement of a downlink specific reference signal carried in each of the plurality of transmission beams, select one of the plurality of transmission beams carrying a downlink specific reference signal with a highest RSRP measurement as output data, and provide a feedback pairing that includes the input data and the output data as the sampled data.

At action 724, the UE 720 determines that the sampled data corresponds to a prediction error of the machine learning-based network. The UE 720 may apply the machine learning-based network with the first configuration to a set of received signal measurements and determine whether an output of the machine learning-based network fails to satisfy one or more criteria. In some aspects, the UE 720 may determine that the output of the machine learning-based network corresponds to a prediction error based on a comparison between at least one signal measurement in the set of received signal measurements and a signal measurement obtained by the UE 720.

At action 726, the UE 720 prepares the first proportion of the sampled data to include signal measurements that correspond exclusively to the prediction error of the machine learning-based network. This allows for a reduced size of the sampled data that needs to be communicated with the BS 710, thus allowing the BS 710 to focus more efficiently on how to improve the machine learning-based network through one or more iterations of training with the proportioned sampled data.

At action 728, the UE 720 may transmit a report in response to the request (e.g., 714) from the BS 710. In some aspects, the UE 720 communicates, with the BS 710, the report including the first proportion of the sampled data that corresponds to the prediction error of the machine learning-based network. In some aspects, the proportioned sampled data includes a feedback pairing of at least one signal measurement in the set of received signal measurements and the output of the machine learning-based network corresponding to the prediction error. In other instances, the UE 720 communicates, with the BS 710, the report including the first proportion along with the second proportion of the sampled data that corresponds to the correct prediction of the machine learning-based network.

At action 716, the BS 710 updates and/or retrains the machine learning-based network based on the report with the sampled data. In some aspects, the BS 710 obtains a second configuration for the machine learning-based network.

At action 718, the BS 710 communicates with the UE 720 an updated machine learning-based network by transmitting the second configuration for the machine learning-based network.

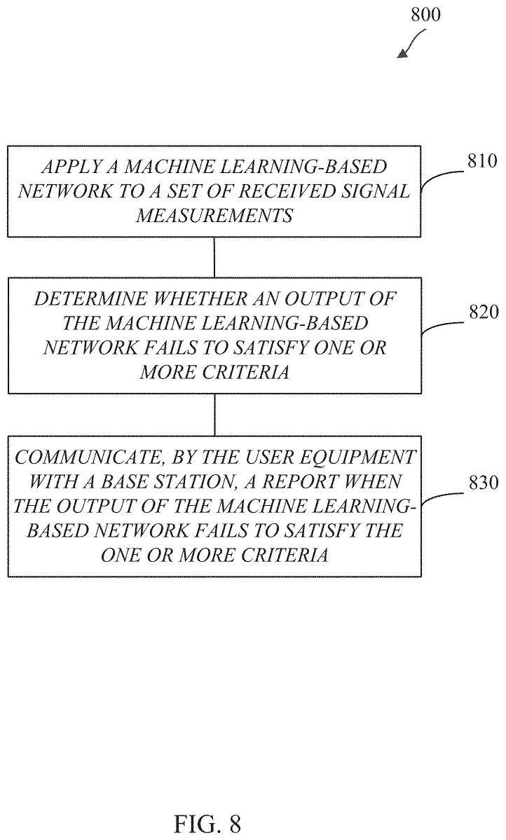

FIG. 8 is a flow diagram of an example process 800 of reporting performed by a user equipment for updating a machine learning network according to some aspects of the present disclosure. Aspects of the process 800 can be executed by a computing device (e.g., a processor, processing circuit, and/or other suitable component) of a wireless communication device or other suitable means for performing the steps. For example, a wireless communication device, such as the UEs 85, 215, and/or 300, may utilize one or more components, such as the processor 302, the memory 304, the reporting communication module 308, the transceiver 310, the modem 312, and the one or more antennas 316, to execute the steps of process 800. As illustrated, the process 800 includes a number of enumerated steps, but aspects of the process 800 may include additional steps before, after, and in between the enumerated steps. In some aspects, one or more of the enumerated steps may be omitted or performed in a different order.

At block 810, the UE applies a machine learning-based network to a set of received signal measurements. In some instances, the UE may be a narrowband communication device and may utilize one or more components, such as the processor 302, the communication module 308, and the transceiver 310, to apply the machine learning-based network to the set of received signal measurements. The machine learning-based network may be provided with a first configuration to the UE, by a BS. The machine learning-based network may have been trained by the BS and/or a cloud server (e.g., the cloud server 260) using prior signal measurements of the downlink channel. In some aspects, the set of received signal measurements may include historical measurements of a plurality of transmission beams associated with the BS and historical signal strength measurements of downlink specific reference signals carried in the plurality of transmission beams.

At block 820, the UE determines whether an output of the machine learning-based network fails to satisfy one or more criteria. For instance, the UE may utilize one or more components, such as the processor 302, the communication module 308, the transceiver 310, the modem 312, and the one or more antennas 316, to determine that the machine learning-based network output produces a prediction error.

At block 830, the UE communicates, with the BS, a report when the output of the machine learning-based network fails to satisfy the one or more criteria. For instance, the UE may utilize one or more components, such as the processor 302, the reporting communication module 308, the transceiver 310, the modem 312, and the one or more antennas 316, to communicate the report with the BS. In some aspects, the report may be represented as a CSI report. In some aspects, the UE may receive an updated machine learning-based network with a second configuration from the BS in response to the report communicated with the BS.

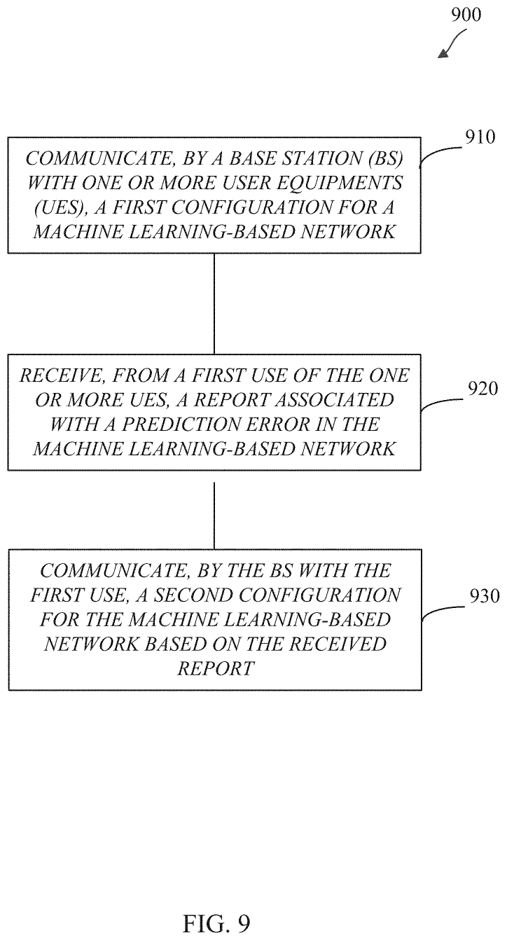

FIG. 9 is a flow diagram of an example process 900 of a machine learning network update performed by a base station using user equipment reporting according to some aspects of the present disclosure. Aspects of the process 900 can be executed by a computing device (e.g., a processor, processing circuit, and/or other suitable component) of a base station or other suitable means for performing the steps. For example, a base station, such as the BSs 95, 205, and/or 400, may utilize one or more components, such as the processor 402, the memory 404, the reporting configuration module 408, the transceiver 410, the modem 412, and the one or more antennas 416, to execute the steps of process 900. As illustrated, the process 900 includes a number of enumerated steps, but aspects of the process 900 may include additional steps before, after, and in between the enumerated steps. In some aspects, one or more of the enumerated steps may be omitted or performed in a different order.

At block 910, the BS communicates, with one or more UEs, a first configuration for a machine learning-based network. For instance, the BS may utilize one or more components, such as the processor 402, the reporting configuration module 408, the transceiver 410, the modem 412, and the one or more antennas 416, to communicate the first configuration for the machine learning-based network. In some aspects, the machine learning-based network includes one or more neural networks.

At block 920, the BS receives, from a first UE of the one or more UEs, a report associated with a prediction error in the machine learning-based network. For instance, the BS may utilize one or more components, such as the processor 402, the reporting configuration module 408, the transceiver 410, the modem 412, and the one or more antennas 416, to receive the report from the first UE.

At block 930, the BS communicates, with one or more UEs, a second configuration for the machine learning-based network. For instance, the BS may utilize one or more components, such as the processor 402, the reporting configuration module 408, the transceiver 410, the modem 412, and the one or more antennas 416, to communicate the second configuration for the machine learning-based network. In some aspects, the BS may update the machine learning-based network by generating the second configuration based on feedback supplied by the first UE within the report. The second configuration of the machine learning-based network may be intended to produce a more accurate prediction such that the prediction can be determined by the UE as a correct prediction.

### Recitations of Some Aspects of the Disclosure

Aspect 1: A method of wireless communication performed by a user equipment (UE), comprising: applying a machine learning-based network to a set of received signal measurements; determining whether an output of the machine learning-based network fails to satisfy one or more criteria; and communicating, by the UE with a base station (BS), a report when the output of the machine learning-based network fails to satisfy the one or more criteria.

Aspect 2: The method of aspect 1, wherein the determining whether the output of the machine learning-based network fails to satisfy the one or more criteria comprises determining that the output of the machine learning-based network corresponds to a prediction error based on a comparison between at least one signal measurement in the set of received signal measurements and a signal measurement obtained by the UE.

Aspect 3: The method of aspect 1 or 2, wherein the communicating the report comprises transmitting, by the UE to the BS in a first subband of a plurality of subbands, sampled data for updating the machine learning-based network.

Aspect 4: The method of any of aspects 1-3, wherein: the first subband includes a plurality of physical uplink shared channels (PUSCHs) multiplexed in at least one of time or frequency in a first portion of a first time period, and the communicating the report comprises transmitting, by the UE, the sampled data in one or more PUSCHs of the plurality of PUSCHs.

Aspect 5: The method of any of aspects 1-3, wherein the sampled data comprises a feedback pairing of at least one signal measurement in the set of received signal measurements and the output of the machine learning-based network associated with the at least one signal measurement.

Aspect 6: The method of any of aspects 1-5, further comprising: receiving, by the UE, a predetermined threshold from the BS for use with the machine learning-based network, wherein the determining whether the output of the machine learning-based network fails to satisfy the one or more criteria comprises: determining that the output of the machine learning-based network fails to satisfy the one or more criteria based on the predetermined threshold.

Aspect 7: The method of any of aspects 1-6, wherein the determining that the output of the machine learning-based network fails to satisfy the one or more criteria comprises: determining whether a first signal measurement in the set of received signal measurements is greater than the predetermined threshold, and determining that the output of the machine learning-based network corresponds to a prediction error when the first signal measurement in the set of received signal measurements is not greater than the predetermined threshold.

Aspect 8: The method of aspect 7, wherein the predetermined threshold corresponds to a target reference signal received power (RSRP) value for a downlink specific reference signal.

Aspect 9: The method of aspect 8, wherein the downlink specific reference signal comprises a synchronization signal block (SSB).

Aspect 10: The method of aspect 7 or 8, wherein the downlink specific reference signal comprises a channel state information reference signal (CSI-RS).

Aspect 11: The method of any of aspects 1-10, further comprising: receiving, by the UE in a first subband of a plurality of subbands, a request for the UE to measure sampled ground-truth data; and obtaining, by the UE, the sampled ground-truth data in response to the request, wherein the determining whether the output of the machine learning-based network fails to satisfy the one or more criteria comprises: determining that the output of the machine learning-based network corresponds to a prediction error based on a comparison between at least one signal measurement in the set of received signal measurements and the sampled ground-truth data.

Aspect 12: The method of aspect 11, wherein: the request comprises a request for measurement of the sampled ground-truth data by the UE at a particular time instance during a first time period, the first subband includes a plurality of physical downlink control channels (PDCCHs) multiplexed in at least one of time or frequency in a first portion of the first time period, and the receiving the request comprises receiving, by the UE, the request in one or more PDCCHs of the plurality of PDCCHs.

Aspect 13: The method of aspect 10 or 11, wherein: the request comprises a request for the UE to perform a plurality of periodical signal measurements of the sampled ground-truth data, the receiving the request comprises receiving, by the UE, the request in a radio resource control (RRC) signal.

Aspect 14: The method of any of aspects 1-13, further comprising: receiving, by the UE in a first subband of a plurality of subbands, a request to communicate sampled data with the BS, wherein the communicating the report comprises communicating, by the UE with the BS, the report with the sampled data, in response to the request.

Aspect 15: The method of any of aspects 1-14, further comprising: receiving, by the UE from the BS, the set of received signal measurements as input data, wherein the set of received signal measurements comprises historical measurements of a plurality of transmission beams associated with the BS and historical signal strength measurements of downlink specific reference signals carried in the plurality of transmission beams; measuring, by the UE, a plurality of transmission beams associated with the BS during a first time period; obtaining, by the UE, a RSRP measurement of a downlink specific reference signal carried in each of the plurality of transmission beams; selecting, by the UE, one of the plurality of transmission beams carrying a downlink specific reference signal with a highest RSRP measurement as output data; and providing a feedback pairing comprising the input data and the output data as the sampled data.

Aspect 16: The method of aspect 15, wherein: the request comprises a request for the UE to perform one or more signal measurements at a particular time instance during the first time period, the first subband includes a plurality of physical downlink control channels (PDCCHs) multiplexed in at least one of time or frequency in a first portion of the first time period, the receiving the request comprises receiving, by the UE, the request in one or more PDCCHs of the plurality of PDCCHs.

Aspect 17: The method of aspect 15 or 16, wherein: the request comprises a request for the UE to perform a plurality of periodical signal measurements during the first time period, the receiving the request comprises receiving, by the UE, the request in a radio resource control (RRC) signal.

Aspect 18: The method of any of aspects 1-17, further comprising: communicating, by the UE with the BS over a plurality of periodic intervals during a second time period greater than the first time period, the sampled data with the plurality of periodical signal measurements, in response to the request.

Aspect 19: The method of aspect 15, wherein: the request comprises a request for the UE to communicate a first proportion of the sampled data that corresponds to a prediction error of the machine learning-based network, the receiving the request comprises receiving, by the UE, the request in a radio resource control (RRC) signal, further comprising: communicating, by the UE with the BS, the report comprising the first proportion of the sampled data that corresponds to the prediction error of the machine learning-based network.

Aspect 20: The method of aspect 15 or 19, wherein: the request comprises a request for the UE to communicate a second proportion of the sampled data that corresponds to a correct prediction of the machine learning-based network, further comprising: communicating, by the UE with the BS, the report comprising the second proportion of the sampled data that corresponds to the correct prediction of the machine learning-based network.

Aspect 21: The method of aspect 15, wherein: the request comprises a request for the UE to communicate a subset of sampled data comprising up to a predetermined number of signal measurements that corresponds to a correct prediction of the machine learning-based network when no sampled data corresponding to a prediction error of the machine learning-based network is present in the sampled data, the receiving the request comprises receiving, by the UE, the request in a radio resource control (RRC) signal, further comprising: determining, by the UE, that no sampled data corresponding to a prediction error of the machine learning-based network is present in the sampled data; and communicating, by the UE with the BS, the report comprising the subset of sampled data corresponding to a correct prediction of the machine learning-based network, the subset of sampled data comprising a number of signal measurements up to the predetermined number of signal measurements.

Aspect 22: The method of aspect 15, wherein: the request comprises a request for the UE to measure sampled data for a predetermined number of time instances in a second time period subsequent to the first time period when sampled data corresponding to a prediction error of the machine learning-based network is present in the sampled data.

Aspect 23: The method of any of aspects 1-15, further comprising: encoding, by the UE, the sampled data into encoded sampled data during a time period of reporting within the first time period; and communicating, by the UE with the BS during the time period of reporting, the encoded sampled data.

Aspect 24: A user equipment (UE), comprising: a memory; a processor coupled to the memory and configured to, when executing instructions stored on the memory, to cause the UE to perform the methods of aspects 1-23.

Aspect 25: A non-transitory computer-readable medium (CRM) having program code recorded thereon, the program code comprises code for causing a UE to perform the methods of aspects 1-23.

Aspect 26: A user equipment (UE) comprising means for performing the methods of aspects 1-23.

Aspect 27: A method of wireless communication performed by a base station (BS), comprising: communicating, by the BS with one or more UEs, a first configuration for a machine learning-based network; receiving, from a first UE of the one or more UEs, a report associated with a prediction error in the machine learning-based network; and communicating, by the BS with the first UE, a second configuration for the machine learning-based network based on the received report.

Aspect 28: The method of aspect 27, wherein the communicating the first configuration for the machine learning-based network comprises: transmitting, by the BS in a first subband of a plurality of subbands, a request for the first UE to communicate sampled data with the BS, wherein the receiving the report comprises receiving, by the BS, the report with the sampled data, in response to the request.

Aspect 29: The method of aspect 27 or 28, the request comprises a request for the UE to perform one or more signal measurements at a particular time instance during a first time period, the first subband includes a plurality of physical downlink control channels (PDCCHs) multiplexed in at least one of time or frequency in a first portion of the first time period, the transmitting the request comprises transmitting, by the BS, the request in one or more PDCCHs of the plurality of PDCCHs.

Aspect 30: The method of any of aspects 27-29, wherein the communicating the first configuration for the machine learning-based network comprises: transmitting, by the BS, a predetermined threshold for use by the first UE with the machine learning-based network in the first configuration, wherein the prediction error in the machine learning-based network is based at least on a comparison between the predetermined threshold and a signal measurement of a corresponding transmission beam.

Aspect 31: The method of aspect 30, wherein the predetermined threshold corresponds to a target reference signal received power (RSRP) value for a downlink specific reference signal.

Aspect 32: The method of aspect 31, wherein the downlink specific reference signal comprises a synchronization signal block (SSB).

Aspect 33: The method of aspect 31 or 32, wherein the downlink specific reference signal comprises a channel state information reference signal (CSI-RS).

Aspect 34: The method of any of aspects 27-33, wherein the communicating the first configuration for the machine learning-based network comprises transmitting, by the BS to the first UE, a set of signal measurements, wherein the set of signal measurements comprises historical measurements of a plurality of transmission beams associated with the BS and historical signal strength measurements of downlink specific reference signals carried in the plurality of transmission beams.

Aspect 35: The method of any of aspects 27-34, wherein the receiving the report comprises receiving, by the BS from the first UE, sampled data obtained by the first UE during a first time period for updating the machine learning-based network.

Aspect 36: The method of any of aspects 27-35, wherein the sampled data comprises a feedback pairing of at least one historical measurement associated with the first configuration and an output of the machine learning-based network associated with the at least one historical measurement.

Aspect 37: The method of any of aspects 27-36, wherein the communicating the first configuration for the machine learning-based network comprises: transmitting, by the BS in a first subband of a plurality of subbands, a request for the first UE to measure sampled ground-truth data, wherein the prediction error in the machine learning-based network is based at least on a comparison between at least one signal measurement in the set of signal measurements and the sampled ground-truth data.

Aspect 38: The method of aspect 37, wherein: the request comprises a request for measurement of the sampled ground-truth data by the first UE at a particular time instance during a first time period, the first subband includes a plurality of physical downlink control channels (PDCCHs) multiplexed in at least one of time or frequency in a first portion of the first time period, and the transmitting the request comprises transmitting, by the BS, the request in one or more PDCCHs of the plurality of PDCCHs.

Aspect 39: The method of aspect 37 or 38, wherein: the request comprises a request for the first UE to perform a plurality of periodical signal measurements of the sampled ground-truth data, the transmitting the request comprises transmitting, by the BS, the request in a radio resource control (RRC) signal.

Aspect 40: The method of aspect 38 or 39, wherein the communicating the first configuration for the machine learning-based network comprises: transmitting, by the BS in a radio resource control (RRC) signal, a request for the first UE to perform a plurality of periodical signal measurements during the first time period.

Aspect 41: The method of any of aspects 38-40, further comprising: receiving, by the BS from the first UE over a plurality of periodic intervals during a second time period greater than the first time period, the sampled data with the plurality of periodical signal measurements, in response to the request.

Aspect 42: The method of any of aspects 35-41, wherein the communicating the first configuration for the machine learning-based network comprises transmitting, by the BS in a radio resource control (RRC) signal, a request for the first UE to communicate a first proportion of the sampled data that corresponds to a prediction error of the machine learning-based network, further comprising: receiving, by the BS from the first UE, the report comprising the first proportion of the sampled data that corresponds to the prediction error of the machine learning-based network.

Aspect 43: The method of any of aspects 35-42, wherein: the request comprises a request for the first UE to communicate a second proportion of the sampled data that corresponds to a correct prediction of the machine learning-based network, further comprising: receiving, by the BS from the first UE, the report comprising the second proportion of the sampled data that corresponds to the correct prediction of the machine learning-based network.

Aspect 44: The method of any of aspects 35-43, wherein the communicating the first configuration for the machine learning-based network comprises transmitting, by the BS in a radio resource control (RRC) signal, a request for the first UE to communicate a subset of sampled data comprising up to a predetermined number of signal measurements that corresponds to a correct prediction of the machine learning-based network when no sampled data corresponding to a prediction error of the machine learning-based network is present in the sampled data, further comprising: receiving, by the BS from the first UE, the report comprising the subset of sampled data corresponding to a correct prediction of the machine learning-based network, the subset of sampled data comprising a number of signal measurements up to the predetermined number of signal measurements.

Aspect 45: The method of any of aspects 35-44, wherein the communicating the first configuration for the machine learning-based network comprises transmitting, by the BS, a request for the first UE to measure sampled data for a predetermined number of time instances in a second time period subsequent to the first time period when sampled data corresponding to a prediction error of the machine learning-based network is present in the sampled data.

Aspect 46: The method of any of aspects 35-45, further comprising: receiving, by the BS from the first UE during a time period of reporting within the first time period, encoded sampled data, wherein the sampled data is encoded into the encoded sampled data during the time period of reporting.

Aspect 47: A base station (BS), comprising: a memory; a processor coupled to the memory and configured to, when executing instructions stored on the memory, to cause the BS to perform the methods of aspects 27-46.

Aspect 48: A non-transitory computer-readable medium (CRM) having program code recorded thereon, the program code comprises code for causing a BS to perform the methods of aspects 27-46.

Aspect 49: A base station (BS) comprising means for performing the methods of aspects 27-46.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a user equipment (UE), comprising:
applying a machine learning-based network to a set of received signal measurements;
determining whether an output of the machine learning-based network fails to satisfy one or more criteria; and
communicating, by the UE with a base station (BS), a report when the output of the machine learning-based network fails to satisfy the one or more criteria.

2. The method of claim 1, wherein the determining whether the output of the machine learning-based network fails to satisfy the one or more criteria comprises determining that the output of the machine learning-based network corresponds to a prediction error based on a comparison between at least one signal measurement in the set of received signal measurements and a signal measurement obtained by the UE.

3. The method of claim 1, wherein the communicating the report comprises transmitting, by the UE to the BS in a first subband of a plurality of subbands, sampled data for updating the machine learning-based network.

4. The method of claim 1, further comprising:
receiving, by the UE, a predetermined threshold from the BS for use with the machine learning-based network,
wherein the determining whether the output of the machine learning-based network fails to satisfy the one or more criteria comprises:
determining that the output of the machine learning-based network fails to satisfy the one or more criteria based on the predetermined threshold.

5. The method of claim 4, wherein the determining that the output of the machine learning-based network fails to satisfy the one or more criteria comprises:
determining whether a first signal measurement in the set of received signal measurements is greater than the predetermined threshold, and
determining that the output of the machine learning-based network corresponds to a prediction error when the first signal measurement in the set of received signal measurements is not greater than the predetermined threshold.

6. The method of claim 5, wherein the predetermined threshold corresponds to a target reference signal received power (RSRP) value for a downlink specific reference signal that includes a synchronization signal block (SSB) and/or a channel state information reference signal (CSI-RS).

7. The method of claim 1, further comprising:
receiving, by the UE in a first subband of a plurality of subbands, a request for the UE to measure sampled ground-truth data; and
obtaining, by the UE, the sampled ground-truth data in response to the request,
wherein the determining whether the output of the machine learning-based network fails to satisfy the one or more criteria comprises:
determining that the output of the machine learning-based network corresponds to a prediction error based on a comparison between at least one signal measurement in the set of received signal measurements and the sampled ground-truth data.

8. The method of claim 7, wherein:
the request comprises a request for measurement of the sampled ground-truth data by the UE at a particular time instance during a first time period,
the first subband includes a plurality of physical downlink control channels (PDCCHs) multiplexed in at least one of time or frequency in a first portion of the first time period, and
the receiving the request comprises receiving, by the UE, the request in one or more PDCCHs of the plurality of PDCCHs.

9. The method of claim 7, wherein:
the request comprises a request for the UE to perform a plurality of periodical signal measurements of the sampled ground-truth data,
the receiving the request comprises receiving, by the UE, the request in a radio resource control (RRC) signal.

10. A user equipment (UE) comprising:
a processor configured to:
apply a machine learning-based network to a set of received signal measurements; and
determine whether an output of the machine learning-based network fails to satisfy one or more criteria; and
a transceiver configured to:
communicate, with a base station (BS), a report when the output of the machine learning-based network fails to satisfy the one or more criteria.

11. The UE of claim 10, wherein:
the transceiver is further configured to:
receive, in a first subband of a plurality of subbands, a request to communicate sampled data with the BS,
the transceiver configured to communicate the report is further configured to:
communicate, with the BS, the report with the sampled data, in response to the request.

12. The UE of claim 11, wherein:
the transceiver is further configured to:
receive, from the BS, the set of received signal measurements as input data, wherein the set of received signal measurements comprises historical measurements of a plurality of transmission beams associated with the BS and historical signal strength measurements of downlink specific reference signals carried in the plurality of transmission beams;
wherein the processor is further configured to:
measure, a plurality of transmission beams associated with the BS during a first time period;
obtain a RSRP measurement of a downlink specific reference signal carried in each of the plurality of transmission beams;
select one of the plurality of transmission beams carrying a downlink specific reference signal with a highest RSRP measurement as output data; and
provide a feedback pairing comprising the input data and the output data as the sampled data.

13. The UE of claim 12, wherein:
the request comprises a request for the UE to perform one or more signal measurements at a particular time instance during the first time period,
the first subband includes a plurality of physical downlink control channels (PDCCHs) multiplexed in at least one of time or frequency in a first portion of the first time period,
the transceiver configured to receive the request is further configured to receive the request in one or more PDCCHs of the plurality of PDCCHs.

14. The UE of claim 12, wherein:
the request comprises a request for the UE to perform a plurality of periodical signal measurements during the first time period,
the transceiver configured to receive the request is further configured to receive the request in a radio resource control (RRC) signal.

15. The UE of claim 14, wherein the transceiver is further configured to:
communicate, with the BS over a plurality of periodic intervals during a second time period greater than the first time period, the sampled data with the plurality of periodical signal measurements, in response to the request.

16. The UE of claim 12, wherein:
the request comprises a request for the UE to communicate a first proportion of the sampled data that corresponds to a prediction error of the machine learning-based network,
the transceiver configured to receive the request is further configured to receive the request in a radio resource control (RRC) signal,
the transceiver is farther configured to:
communicate, with the BS, the report comprising the first proportion of the sampled data that corresponds to the prediction error of the machine learning-based network.

17. The UE of claim 16, wherein:
the request comprises a request for the UE to communicate a second proportion of the sampled data that corresponds to a correct prediction of the machine learning-based network,
the transceiver is further configured to:
communicate, with the BS, the report comprising the second proportion of the sampled data that corresponds to the correct prediction of the machine learning-based network.

18. The UE of claim 12, wherein:
the request comprises a request for the UE to communicate a subset of sampled data comprising up to a predetermined number of signal measurements that corresponds to a correct prediction of the machine learning-based network when no sampled data corresponding to a prediction error of the machine learning-based network is present in the sampled data,
the transceiver configured to receive the request is further configured to receive the request in a radio resource control (RRC) signal,
the processor is further configured to:
determine that no sampled data corresponding to a prediction error of the machine learning-based network is present in the sampled data; and
the transceiver is further configured to:
communicate, with the BS, the report comprising the subset of sampled data corresponding to a correct prediction of the machine learning-based network, the subset of sampled data comprising a number of signal measurements up to the predetermined number of signal measurements.

19. The UE of claim 12, wherein:
the request comprises a request for the UE to measure sampled data for a predetermined number of time instances in a second time period subsequent to the first time period when sampled data corresponding to a prediction error of the machine learning-based network is present in the sampled data.

20. A method of wireless communication performed by a base station (BS), comprising:
communicating, by the BS with one or more UEs, a first configuration for a machine learning-based network;
receiving, from a first UE of the one or more UEs, a report associated with a prediction error in the machine learning-based network; and
communicating, by the BS with the first UE, a second configuration for the machine learning-based network based on the received report.

21. The method of claim 20, wherein the communicating the first configuration for the machine learning-based network comprises transmitting, by the BS to the first UE, a set of signal measurements, wherein the set of signal measurements comprises historical measurements of a plurality of transmission beams associated with the BS and historical signal strength measurements of downlink specific reference signals carried in the plurality of transmission beams.

22. The method of claim 21, wherein the receiving the report comprises receiving, by the BS from the first UE, sampled data obtained by the first UE during a first time period for updating the machine learning-based network.

23. The method of claim 22, wherein the communicating the first configuration for the machine learning-based network comprises transmitting, by the BS in a radio resource control (RRC) signal, a request for the first UE to communicate a first proportion of the sampled data that corresponds to a prediction error of the machine learning-based network,
further comprising:
receiving, by the BS from the first UE, the report comprising the first proportion of the sampled data that corresponds to the prediction error of the machine learning-based network.

24. The method of claim 22, further comprising:
receiving, by the BS from the first UE during a time period of reporting within the first time period, encoded sampled data, wherein the sampled data is encoded into the encoded sampled data during the time period of reporting.

25. The method of claim 21, wherein the communicating the first configuration for the machine learning-based network comprises:
transmitting, by the BS in a first subband of a plurality of subbands, a request for the first UE to measure sampled ground-truth data,
wherein the prediction error in the machine learning-based network is based at least on a comparison between at least one signal measurement in the set of signal measurements and the sampled ground-truth data.

26. A base station (BS), comprising:
a transceiver configured to:
communicate, with one or more UEs, a first configuration for a machine learning-based network;
receive, from a first UE of the one or more UEs, a report associated with a prediction error in the machine learning-based network; and
communicate, with the first UE, a second configuration for the machine learning-based network based on the received report.

27. The BS of claim 26, wherein the transceiver configured to communicate the first configuration for the machine learning-based network is further configured to:
transmit, in a first subband of a plurality of subbands, a request for the first UE to communicate sampled data with the BS,
wherein the transceiver configured to receive the report is further configured to receive the report with the sampled data, in response to the request.

28. The BS of claim 27, wherein:
the request comprises a request for the UE to perform one or more signal measurements at a particular time instance during a first time period,
the first subband includes a plurality of physical downlink control channels (PDCCHs) multiplexed in at least one of time or frequency in a first portion of the first time period,
the transceiver configured to transmit the request is further configured to transmit the request in one or more PDCCHs of the plurality of PDCCHs.

29. The BS of claim 26, wherein the transceiver configured to communicate the first configuration for the machine learning-based network is further configured to:
transmit a predetermined threshold for use by the first UE with the machine learning-based network in the first configuration,
wherein the prediction error in the machine learning-based network is based at least on a comparison between the predetermined threshold and a signal measurement of a corresponding transmission beam.

30. The BS of claim 29, wherein the predetermined threshold corresponds to a target reference signal received power (RSRP) value for a downlink specific reference signal that includes a synchronization signal block (SSB) and/or a channel state information reference signal (CSI-RS).
